(19) United States
(12) Patent Application Publication
(10) Pub. No.: US 2026/0288589 A1
(43) Pub. Date: Sep. 24, 2026

(54) SYSTEMS AND METHODS FOR MANAGING UNAVAILABLE STARTUP DATA FOR A DATA PROCESSING SYSTEM DURING UNRECOVERABLE BOOT EVENT

(71) Applicant: Dell Products L.P., Round Rock, TX (US)

(72) Inventors: IBRAHIM SAYYED, Georgetown, TX (US); ADOLFO SANDOR MONTERO, Pflugerville, TX (US); XIAOMEI ZHU MILLER, Round Rock, TX (US); PHANINDRA BHARGAV TALASILA, Georgetown, TX (US)

(21) Appl. No.: 19/085,716

(22) Filed: Mar. 20, 2025

(51) Int. Cl. G06F 11/14

(52) U.S. Cl. CPC G06F 11/1417; G06F 11/1482

(57) ABSTRACT

Methods and systems for managing operation of data processing system are disclosed. To manage the data processing system, a management controller of the data processing system may identify that a portion of startup data stored in a boot storage device is unavailable for use in startup of the data processing system. The management controller may make a copy of the startup data into memory of hardware resources of the data processing system and obtain replacement data for the portion of the startup data in order to perform a reconstructing process to obtain reconstructed copy of the startup data. The reconstructed copy of the startup data may be used to perform a new boot process initiated by a processor of the hardware resources to place the data processing system in desired operating state.

### FIELD

Embodiments disclosed herein relate generally to managing a data processing system. More particularly, embodiments disclosed herein relate to systems and methods for managing operation of data processing systems including sound systems using a management controller of the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a second block diagram illustrating a data processing system in accordance with an embodiment.

FIG. 1C shows a third block diagram illustrating a data processing system in accordance with an embodiment.

FIGS. 2A-2B show interaction diagrams in accordance with an embodiment.

FIG. 3 shows a flow diagram illustrating a method of managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing systems may provide computer-implemented services to any type and number of other devices and/or users of the data processing systems. The computer-implemented services may include any quantity and type of such services.

To provide the computer-implemented services, a data processing system may perform a booting process to initialize operation of hardware resources hosted by the data processing system. To do so, a processor (e.g., a central programming unit (CPU)) of the hardware resources may utilize startup data (e.g., basic input/output system (BIOS) firmware, system configuration files, etc.) that may be stored on a boot storage device. The boot storage device may include, for example, a non-volatile memory storage device (e.g., serial peripheral interface flash).

However, an unrecoverable boot failure may occur when the processor is unable to perform the startup process (otherwise referred herein as boot process) using startup data stored on the boot storage device. The storage device may include a non-volatile memory (NVMe) storage device that may include a boot partition (e.g., a section of the storage device allocated to store data relevant to the booting process). For example, the processor may be unable to perform the startup process when a portion of the startup data hosted by the boot storage device includes erroneous data (e.g., corrupted firmware, malicious data, incompatible firmware version, etc.), a firmware image is improperly flashed on the boot storage device, and/or any other causes impacting an ability of the processor to perform the startup process. Consequently, at least a portion of the hardware resources may be inoperable.

To modify operation of the data processing system in an event of compromise and/or reduced functionality of at least a portion of the hardware resources, the data processing system may host a management controller that may operate independently from the hardware resources and may be distinct from and adapted to manage the hardware resources. For example, the management controller may operate during the startup process and/or regardless of an outcome of the startup process performed by booting components (e.g., the boot storage device and/or the processor) of the hardware resources.

Thus, to improve a likelihood that the data processing system may successfully perform a startup process, the management controller may obtain replacement data and reconstruct an instance of startup data while hosted in memory of the hardware resources in the event that the processor is unable to perform the startup process using the unavailable portion of the startup data hosted by the boot storage device. The startup data include startup files, configurations, etc. usable to startup and/or boot the data processing system into a desired operating state (e.g., via the processor performing a successful startup of the data processing system).

To identify the occurrence of the unrecoverable startup failure, the management controller may monitor a startup status by obtaining information regarding the startup process from the processor using a side band communication channel. If a portion of the startup data is unusable (e.g., corrupted, not stored within one of the storage devices, etc.), the management controller may obtain a copy of the equivalent blocks of startup data stored in a boot partition of a storage device hosted by hardware resources of the data processing system.

The management controller may provide and/or obtain (e.g., read and/or write) data from the boot partition using a second side band communication channel. For example, the management controller may load into memory an updated copy of the reconstructed startup data and/or perform any other actions.

Once obtained, the recovery image may be used by the processor of the hardware resources to subsequently initiate an updated startup process to place the data processing system in a desired operating state (e.g., successfully perform a boot of the data processing system).

Thus, embodiments disclosed herein may provide an improved method for managing operation of a data processing system by using a management controller to obtain replacement data for a portion of the startup data that is unavailable for use in the startup of the data processing system. The replacement data for the portion of the startup data may be obtained from the boot partition of a storage device based on identifying the corrupted blocks of the startup data and read into memory to obtain a reconstructed copy of the startup data. By doing so, a processor of the data processing system may be more likely to perform a successful startup process to provision desired computer-implemented services provided by the data processing system.

In an embodiment, a method for managing operation of a data processing system is provided. The method may include: making, by a management controller of the data processing system, an identification that a portion of startup data stored in a boot storage device is unavailable for use in startup of the data processing system, the portion of the startup data being required for completion of the startup; based on the identification: making, by the management controller, a copy of the startup data from the boot storage device into memory of hardware resources of the data processing system; obtaining, by the management controller and from a boot partition of a storage device via a side band channel, replacement data for the portion of the startup data; reconstructing, by the management controller, an instance of the startup data using the copy of the startup data and the replacement data; performing, by a processor of the hardware resources, the startup using the reconstructed instance of the startup data to place the data processing system in a desired operating state; and providing computer-implemented services while the data processing system is in the desired operating state.

The instance of the startup data may include at least one characteristic of a list of characteristics consisting of: a complete representation of the startup data; and a memory data structure stored in the memory.

Making the identification may include: reading error correction code data for the portion of the startup data from the boot storage device; and identifying, based on the error correction code data, that the portion of the startup data is unrecoverable in order to use in the startup of the data processing system.

The portion of the startup data is unavailable due to being unreadable from the boot storage device and unable to be reconstructed due to a level of corruption that exceeds recoverability by the error correction code data.

Making the copy of the startup data may be performed while the processor may be selectively powered and other components of the hardware resources are depowered.

Obtaining the replacement data may include: identifying, by the management controller and via the side band channel, the blocks from the storage device that are corrupted; identifying, by the management controller, corresponding blocks from the boot partition; and reading, by the management controller, the corresponding blocks into the memory.

Reconstructing the instance of the startup data may include: identifying, by the management controller, the blocks of data corresponding to the portion of the startup data in the memory; and overwriting the blocks of data with the replacement data in the memory.

The method may also include: prior to the storing of the startup data: selectively powering, by the management controller and via a sideband channel, the storage device to gain access to the boot partition, wherein a corrupt recovery image stored in the boot partition is identified while the storage device is selectively powered and other components of the hardware resources are depowered, the corrupt recovery image being unusable during the boot to place the data processing system in the desired operating state.

The method may also include: prior to making the identification that the portion of the startup data stored in the boot storage device is unavailable for use, selectively powering, by the management controller, the storage device, wherein the startup data is stored in the boot partition while the storage device is selectively powered and other components of the hardware resources are depowered.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

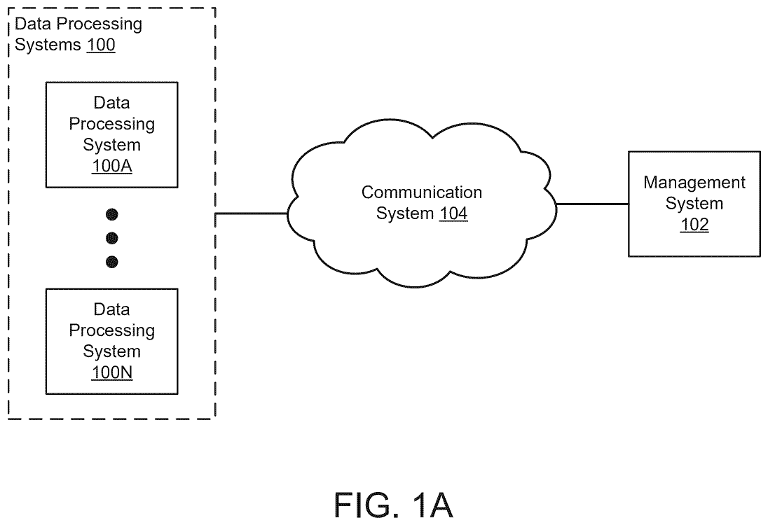

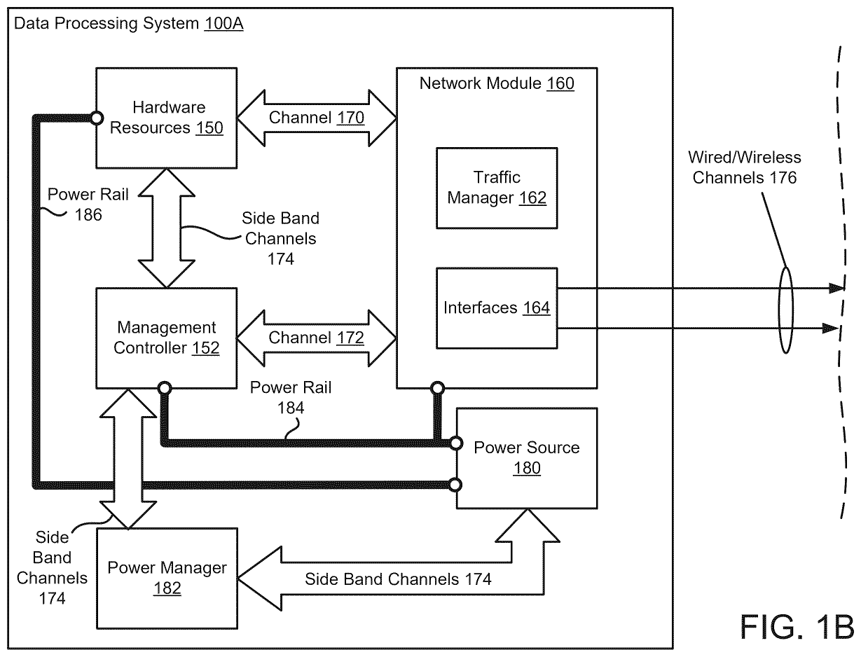

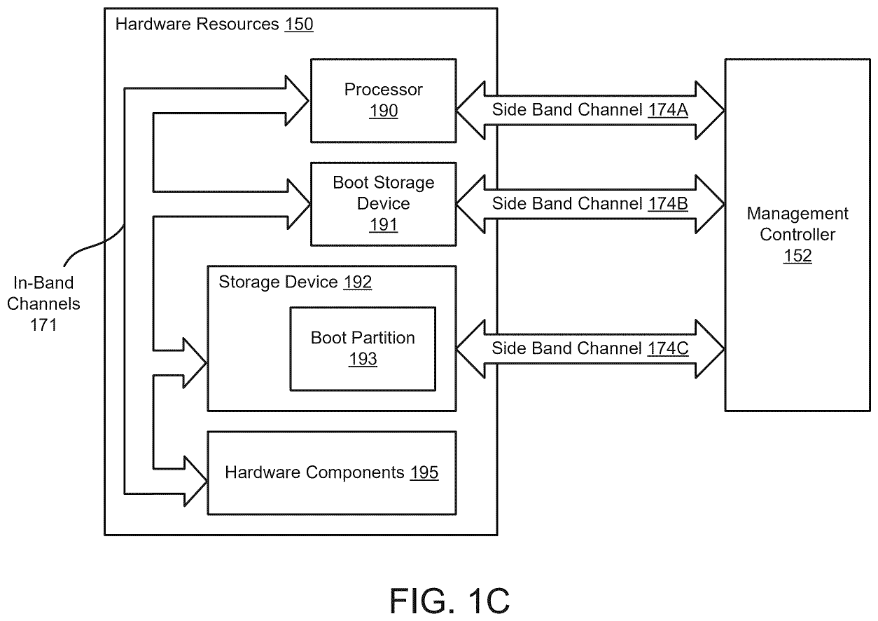

Turning to FIG. 1A, a block diagram illustrating a system in accordance with an embodiment is shown. The system shown in FIG. 1A may provide for management of data processing systems that may provide, at least in part, computer-implemented services. The system may include any number of data processing systems 100 (e.g., computing devices) that may each include any number of hardware components (e.g., processors, memory modules, storage devices, communications devices). The hardware components may support execution of any number and types of applications (e.g., software components). Changes in available functionalities of the hardware and/or software components may provide for various types of different computer-implemented services to be provided over time.

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIG. 1B for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1A). Other types of computer-implemented services may be provided by the system shown in FIG. 1A without departing from embodiments disclosed herein.

The computer-implemented services may be provided at least in part, by hardware resources of data processing systems 100. To provide the computer-implemented services, a data processing system may perform a booting process to initialize operation of the hardware resources. To do so, a processor (e.g., a central programming unit (CPU)) of the hardware resources may utilize startup data (e.g., basic input/output system (BIOS) firmware, system configuration files, etc.) that may be stored on a boot storage device. The boot storage device may include, for example, a non-volatile memory storage device (e.g., serial peripheral interface flash).

By performing the booting process, the hardware resources of the data processing system may be operably connected to each other (e.g., via in-band channels) and an operating system may be loaded to provide management functionality.

However, an unrecoverable boot failure may occur when the processor is unable to perform the booting process using the startup data stored on the boot storage device. For example, the processor may be unable to perform the booting process when at least a portion of the startup data hosted by the boot storage device includes erroneous data (e.g., corrupted firmware, malicious data, incompatible firmware version, etc.), a firmware image is improperly flashed on the boot storage device, and/or any other causes impacting an ability of the processor to perform the booting process. For example, the startup data and/or a portion of the startup data (e.g., a bit of data) may become unavailable (e.g., corrupted, unreadable, etc.) for use during performance of the startup of the data processing system.

To attempt to recover unavailable portions of the startup data, error correction code “ECC” data may allow identification and correction of errors without requiring full duplication of the stored data (e.g., the startup data). For example, instead of storing a full duplicate copy of an 8-bit block, a smaller number of extra bits (e.g., 3 bits) that server as an error correction code may be generated (e.g., using an algorithm that processes the original 8 bits and encodes information about their values and/or any other mechanisms) and stored in the boot storage device. Therefore, when the processor reads the startup data, it may also read the error correction code data to identify if any of the bits of data have flipped (e.g., the value has changed). If a single-bit error is detected, the error correction code data may be used to identify and correct the specific flipped bit.

However, if the error is unrecoverable using the error correction codes (e.g., bits of data that cannot be recovered), the startup data may not be available to use in order to complete the startup process of the data processing system. Consequently, the at least a portion of the hardware resources may be inoperable.

To modify operation of the data processing system in an event of compromise and/or reduced functionality of at least a portion of the hardware resources, the data processing system may host a management controller that may operate independently from the hardware resources and may be distinct from and adapted to manage the hardware resources. For example, the management controller may operate during the booting process and/or regardless of an outcome of the booting process performed by booting components (e.g., the boot storage device and/or the processor) of the hardware resources.

In general, embodiments disclosed herein relate to systems, devices, and methods for managing operation of a data processing system. To manage the operation of a data processing system, the management controller may reconstruct an instance of startup data in memory of hardware resources of the data processing system in an event that the processor is unable to perform a startup of the data processing system using a portion of the startup data hosted by a boot storage device of the data processing system.

Thus, to improve a likelihood that the data processing system may successfully perform a startup process, the management controller may obtain a copy of the startup data from a remote entity in the event that the processor is unable to perform the startup process using corrupted startup data (and/or a portion of the startup data) hosted by the boot storage device. The startup data may include recovery files, configurations, etc. usable to complete the startup of the data processing system into a desired operating state (e.g., via the processor performing a successful startup of the data processing system).

To identify the occurrence of the unrecoverable startup failure, the management controller may monitor a startup status by obtaining information regarding the startup process from the processor using a side band communication channel. If a portion of the startup data is unavailable (e.g., corrupted, not stored within the boot storage device, etc.), the management controller may provide and/or obtain (e.g., read and/or write) replacement data for the portion of the startup data from the boot partition using a second side band communication channel. For example, the management controller may store an updated copy of startup data as the latest copy to the boot partition (e.g., based on obtaining the updated copy of the startup data from a trusted external entity), obtain the latest copy of the startup data from the boot partition (e.g., based on identifying that an unrecoverable startup failure has occurred), and/or perform any other actions.

Once obtained, the replacement data and the copy of the startup data may be used by the management controller to reconstruct an instance of the startup data in memory of the hardware resources of the data processing system. The management controller may subsequently initiate a new boot process for the processor to use the reconstructed instance of the startup data in memory to perform the startup process and place the data processing system in a desired operating state.

To provide the above noted functionality, the system may include data processing systems 100, and management system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with management system 102 via an out-of-band communication channel.

While providing the at least a portion of the computer-implemented services, a data processing system (e.g., 100A) of data processing systems 100 may communicate with and/or obtain information from management system 102. For example, data processing system 100A may obtain instructions relevant to updated startup software (e.g., an updated firmware version), implementing a startup software recovery policy, management requests to modify operation of the hardware resources (e.g., installing new applications), and/or any other information. Data processing system 100A may subsequently perform actions based on the information obtained from management system 102 to update operation of data processing system 100A.

Management system 102 may, as discussed above, provide remote management services. Management system 102 may include, for example, a second data processing system operated an owner of data processing systems 100. To provide the remote management services, management system 102 may interact with data processing systems 100 to obtain and/or provide information (e.g., data) relevant to operation of data processing systems 100. For example, management system 102 may generate and provide a startup data recovery policy to a data processing system of data processing systems 100 for use in storing an updated copy of startup data in a boot partition, restoring startup data hosted on a boot storage device of the data processing system, and/or any other purposes.

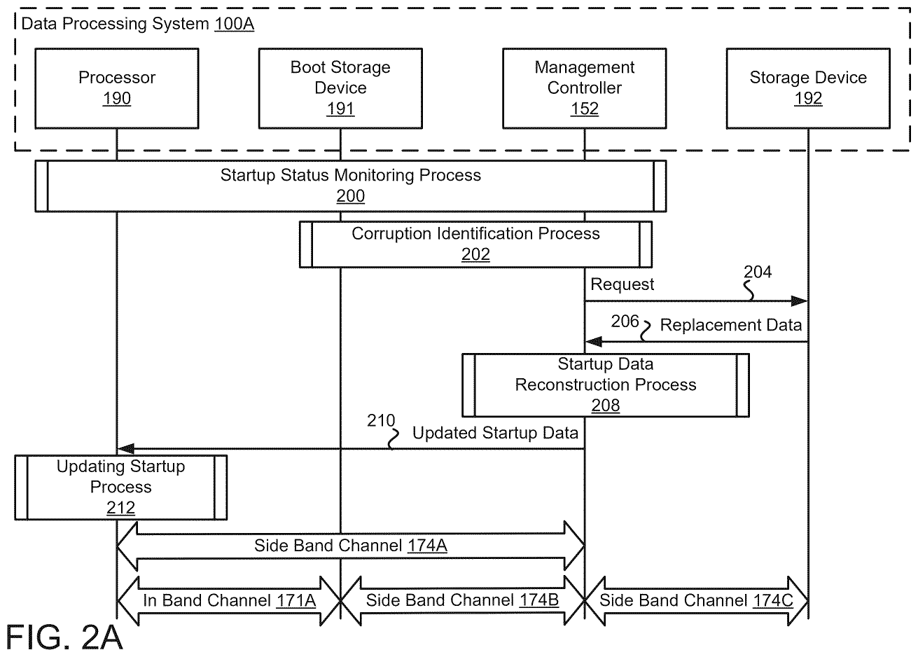

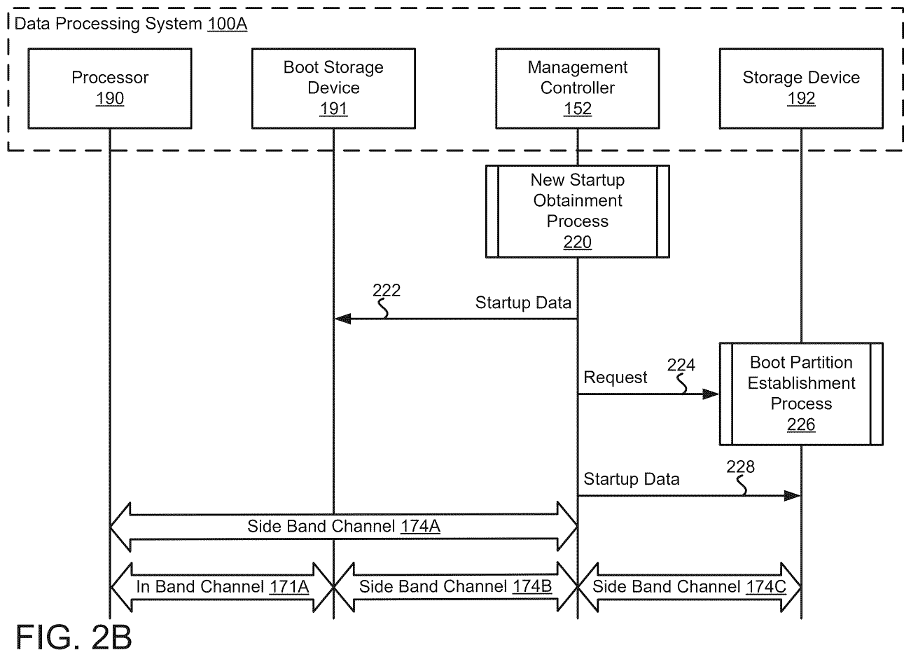

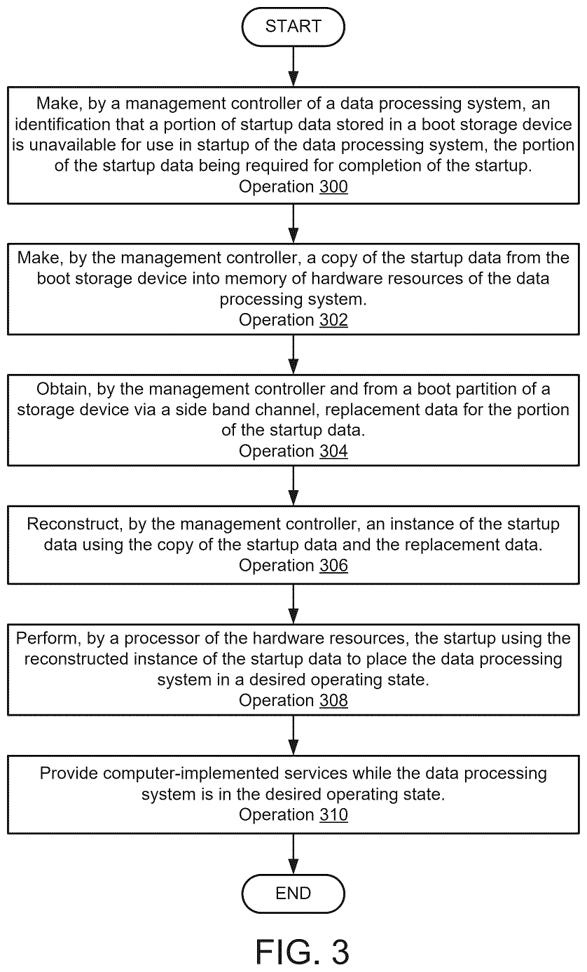

While providing their functionality, any of data processing systems 100, and management system 102 may provide all or a portion of the methods shown in FIGS. 2A-3.

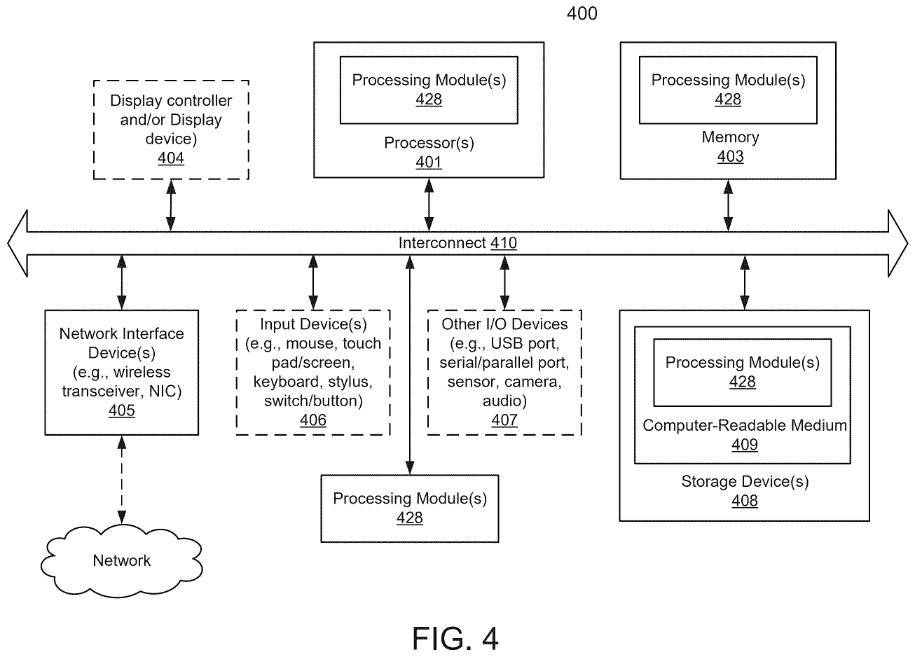

Communication system 104 may allow any of data processing systems 100, and management system 102 to communicate with one another (and/or with other devices not illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage operation of a data processing system by obtaining and storing a recovery image to a boot partition of a storage device hosted by hardware resources of the data processing system when an unrecoverable boot failure is identified by a management controller of the data processing system. By doing so, the data processing system may be rebooted using the recovery image to place the data processing system in desired operating state.

While providing their functionality, any of data processing systems 100 and management system 102 may provide all or a portion of the methods shown in FIGS. 2A-3.

Any of the components illustrated in FIG. 1A may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and/or types of communication protocols (e.g., such as the internet protocol). Communication system 104 may include any number of in-band communication channel and/or out-of-band communication channels.

While illustrated in FIG. 1A as including a limited number of specific components, a system in accordance with an embodiment may include fewer, additional, and/or different components than those illustrated therein. For example, while the system of FIG. 1A shows a single management system (e.g., 102), it will be appreciated that the system may include any number of management systems.

Turning to FIG. 1B, a diagram illustrating data processing system 100A in accordance with an embodiment is shown. Data processing system 100A may be similar to any of data processing systems 100A-100N shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components. Hardware resources 150 may (e.g., via the processor) provide the computer-implemented services desired by users of data processing system 100.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100) to another device via any number of intermediate networks (e.g., via wired/wireless channels 176 that are part of the networks).

In addition, different configurations of hardware resources 150 and/or software resources may be implemented by data processing system 100 based on the type of computer-implemented services that are to be provided. Modifications to configurations of hardware resources 150 and/or the software resources may lead to downtime for data processing system 100 and may consume network bandwidth of channel 170.

To reduce the likelihood of the applications and/or other in-band entities from being indirectly compromised, data processing system 100 may include management controller 152 and network module 160. Each of these components of data processing system 100 is discussed below.

Management controller 152 may operate independently from hardware resources 150 and, therefore, hardware resources 150 may not host and/or manage operation of management controller 152. In addition, management controller 152 may be distinct from hardware resources 150 and, therefore, may be physically separate from hardware resources 150. Management controller 152 may also be operably connected to communication components of data processing system 100 via separate channels (e.g., 172) from the in-band components.

Management controller 152 may be implemented, for example, using a system on a chip or other type of independently operating computing device (e.g., independent from the in-band components, such as hardware resources 150, of a host data processing system 100). Management controller 152 may provide various management functionalities for data processing system 100. For example, management controller 152 may monitor various ongoing processes performed by the in-band component, may manage power distribution, thermal management, and/or other functions of data processing system 100A.

To do so, management controller 152 may be operably connected to various components via side band channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via side band channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similar processes may be used to facilitate outbound communications from the applications.

Information provided to the application by management controller 152 may include, for example, instructions for implementation of computer-implemented services desired by users of data processing system 100.

To facilitate communication with other devices, data processing system 100 may include network module 160. Network module 160 may provide communication services for in-band components and out-of-band components (e.g., management controller 152) of data processing system.

To provide the above-described functionalities, network module 160 may include traffic manager 162, interfaces 164, and may host an instance of a TCP/IP stack to facilitate communication with other devices independently of any of the in-band components (e.g., does not rely on any hosted software, hardware components, etc.). Accordingly, compromise of any of hardware resources 150 and hosted component may not result in indirect compromise of network module 160, management controller 152, and entities hosted by management controller 152.

Management controller 152 may be operably connected to communication components of data processing system 100 via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 100 may include network module 160. Network module 160 may provide communication services for in-band components and out-of-band components (e.g., management controller 152) of data processing system 100. To do so, network module 160 may include traffic manager 162 and interfaces 164.

Traffic manager 162 may include functionality to (i) discriminate traffic directed to various network endpoints advertised by data processing system 100, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100 may appear to be two independent network entities, that may independently addressable, and otherwise unrelated to one another.

Network module 160 may utilize the instance of the TCP/IP stack to allow hardware resources 150 and/or management controller 152 to communicate with other devices via packet switched networks and/or other types of communication networks.

To facilitate management of data processing system 100 over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100 may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails (e.g., by providing instructions via side band channels 174). Management controller 152 may cooperate with power manager 182 to manage supply of power to these power domains. Management controller 152 may communicate with power manager 182 via side band channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations described in FIG. 2A.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host processor 190, boot storage device 191, and storage device 192. For example, to place a data processing system (e.g., 100A) in a desired operating state, data processing system 100A may perform a booting process to initialize hardware resources and facilitate operation of an operating system. To do so, processor 190 may execute instructions indicated by boot data (e.g., firmware, system configuration, etc.) hosted by boot storage device 191.

Boot storage device 191 may include, for example, non-volatile flash memory (e.g., serial peripheral interface (SPI) flash) that may be hosted on a motherboard and adapted to store information, such as firmware, an image of a management entity (BIOS, universal extensible firmware interface (UEFI), etc.), system configuration files, and/or any other information usable to boot data processing system 100A. Because boot storage device 191 may have a limited storage capacity, storage device 192 may be used to store additional information (e.g., other copies of boot data).

Storage device 192 may include, for example, a second storage device such as a non-volatile memory express (NVMe) based solid-state drive. Storage device 192 may include a boot partition (193) that may be configured to store data usable to boot data processing system 100A (e.g., a latest stable copy of boot data, bootloader files, configuration files, etc.). Boot partition 193 may include an allocated section of storage device 192 that may, for example, be isolated from other memory sections of storage device 192.

Processor 190 may include a central processing unit (CPU) that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171.

However, at least a portion of in-band channels 171 may not be functional and/or may have reduced functionality during booting of data processing system 100A and/or as a result of an undesired boot event. For example, in an event that storage device 192 and/or hardware components 195 are not initialized during booting, processor 190 may not be able to communicate with storage device 192 to obtain a copy of boot data (e.g., a backup copy, a recovery file, etc.) for use in rebooting and placing data processing system 100A in a desired operating state.

Thus, to improve a likelihood that data processing system 100A may be booted and placed in the desired operating state, management controller 152 may perform management functionalities using any number and/or type of side band channels (e.g. 174). For example, management controller may obtain information (e.g., telemetry data, process results, boot times, etc.) regarding a startup status from processor 190 using side band channel 174A, replace a copy of undesired startup data hosted by boot storage device 191 with a latest copy of startup data using side band channel 174B, read and/or write boot data to boot partition 193 of storage device 192 using side band channel 174C, and/or perform any other actions by communicating with components of hardware resources regardless of a startup status of data processing system 100A.

To further clarify embodiments disclosed herein, interaction diagrams in accordance with an embodiment are shown in FIGS. 2A-2B. The interaction diagrams may illustrate how data may be obtained and used within the system of FIGS. 1A-1C.

In the interaction diagram, processes performed by and interactions between components of a system in accordance with an embodiment are shown. In the diagram, components of the system are illustrated using a first set of shapes (e.g., 190, 191, etc.), located towards the top of each figure. Lines descend from these shapes. Processes performed by the components of the system are illustrated using a second set of shapes (e.g., 200, 210, etc.) superimposed over these lines.

Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 206. However, it will be appreciated that the processes and interactions may be performed in different orders, any may be omitted, and other processes or interactions may be performed without departing from embodiments disclosed herein.

The processes shown in FIG. 2A may be performed by any entity shown in the systems of FIGS. 1A-1C (e.g., a device similar to data processing system 100A, a device similar to management system 102, etc.) and/or another entity without departing from embodiments disclosed herein.

Turning to FIG. 2A, a first interaction diagram in accordance with an embodiment is shown. The interaction diagram may illustrate processes and interactions that may occur during startup of a data processing system when an unrecoverable boot failure is identified to have occurred during a boot of the data processing system.

To identify that an unrecoverable boot failure has occurred, boot status monitoring process 200 may be performed. During boot status monitoring process 200, processor 190 may attempt to startup data processing system 100A using startup data hosted by boot storage device 191 (e.g., described above and shown in FIG. 1C), and management controller 152 may monitor the startup via a side band communication channel. For example, processor 190 may attempt to startup data processing system 100A by receiving a reset signal (e.g., via a power-on process), initializing registers, retrieving data (e.g., BIOS, UEFI, etc.) stored on boot storage device 191 via an in-band channel (e.g., in band channels 171 shown in FIG. 1C), attempting to execute instructions (e.g., firmware code) based on the data, and/or performing any other actions.

During startup status monitoring process 200, processor 190 may attempt to startup data processing system 100A using startup data hosted by storage device 192 (e.g., described above and shown in FIG. 1C), and management controller 152 may monitor the startup via a side band communication channel. For example, processor 190 may attempt to startup data processing system 100A by receiving a reset signal (e.g., via a power-on process), initializing registers, retrieving data (e.g., BIOS, UEFI, etc.) stored on storage device 192 via an in-band channel 171B, attempting to execute instructions (e.g., firmware code) based on the data, and/or performing any other actions.

While attempting to startup, processor 190 may be operably connected to storage device 192 via in-band channel 171B but may not operably connected to boot storage device 191 (and/or any other hardware components). In-band channel 171B may include, for example, a limited communication channel between processor 190 and storage device 192 that may be facilitated using a signal multiplexer that may enable processor 190 to communicate with storage device 192 (e.g., using a system bus) while limiting communication with the other hardware components prior to a management entity (e.g., an operating system, drivers, etc.) being loaded as a result of a successful startup.

Accordingly, management controller 152 may monitor and/or obtain information from processor 190 using side band channel 174A. For example, management controller 152 may obtain data (e.g., telemetry data) from processor 190, compare the data to criteria (e.g., a startup timeout time), and determine that an unrecoverable startup failure has occurred, management controller may obtain a copy of startup data useable to startup the data processing system into a desired operating state.

To identify the portion of the startup data that is unavailable (e.g., due to corruption), corruption identification process 202 may be performed. During corruption identification process 202, a copy of the startup data may be stored (e.g., read) into memory and used to identify blocks (e.g., of the startup data) that may be corrupted. For example, management controller 152 may (i) obtain the copy of the startup data from boot storage device 191 via side band channel 174B to load into memory of the hardware resources of data processing system 100A, (ii) use the error correction codes to identify the blocks that are corrupted, and/or (iii) perform any other processes to identify the portion of the startup data that is unavailable for use to perform the startup of the data processing system. The corrupted blocks of startup data that are identified as a result of performing corruption identification process 202 may be used to identify equivalent blocks of startup data stored in storage device 192 to replace the corrupted blocks of the startup data.

At interaction 204, a request may be provided to storage device 192 by management controller 152. The request may be transmitted to storage device 192 via side band channel 174C. The request may include, for example, a request to read replacement data (e.g., an image of a management entity, firmware, system configuration files, etc. usable to replace the portion of the startup data), an identifier for the replacement data for portion of the startup data, a logical block address (e.g., of a boot partition), and/or any other information.

Once obtained, the request may be used to initiate identification of the replacement data for the respective data processing system (e.g., data processing system 100A). The replacement data (e.g., data usable for performing a startup) for the respective data processing system (e.g., data processing system 100A) may be identified based on the identified portion of the startup data that is unavailable for use in the startup of the data processing system (e.g., as identified during corruption identification process 202).

At interaction 206, the replacement data may be provided to management controller 152 by storage device 192. For example, the replacement data may be provided by: (i) locating the requested replacement data (e.g., on the boot partition of storage device 192), (ii) transferring the requested replacement data to management controller via side band channel 174C and/or using a data transfer protocol (e.g., non-volatile memory express, universal serial bus, etc.), and/or via any other processes. The replacement data may include a version of the startup data obtained from an external entity and used in performing a successful startup of the data processing system 100A. Refer to FIG. 2B for additional information regarding obtaining an updated copy of the startup data.

Once obtained, the replacement data for the portion of the startup data may be stored, at least temporarily, by management controller 152. Additionally, management controller 152 may verify at least a portion of the startup data. For example, management controller 152 may verify an integrity of the data (e.g., firmware, system configuration files, etc.).

To reconstruct the portion of the startup data that is unavailable for use in the startup, startup data reconstruction process 208 may be performed. During startup data reconstruction process 208, a copy of the startup data (e.g., that may include erroneous data causing the unrecoverable startup failure) in memory may be reconstructed (e.g. replaced) with the updated copy of the startup data (e.g., the replacement data) to obtain a complete representation of the startup data (e.g., a data structure stored in memory).

Once restored, updating startup process 212 may be performed to attempt to startup data processing system 100A using the reconstructed instance of the startup data while loaded in memory of the data processing system. During updating startup process 212, processor 190 may retrieve the reconstructed startup data from management controller 152, execute instructions (e.g., firmware code) based on the reconstructed startup data, initialize hardware resources, and provide control to a management entity.

By executing the instructions based on the reconstructed instance of the startup data, processor 190 may perform operations that may place data processing system 100A in a desired state (e.g., completion of a startup of the data processing system using the version of the startup data). For example, software and/or hardware resources may be validated (e.g., during a power on self-test), the hardware resources may be configured and/or initialized based on the startup data, an operating system may be loaded to memory of data processing system 100A (e.g., using a bootloader), and/or any other actions may be performed.

Side band channels (e.g., 174A-174C) may be used to facilitate communication between management controller 152 and storage device 192, and are shown to indicate that management controller 152 may interface with processor 190, startup storage device 191, and storage device 192 regardless of a status of in-band channels (e.g., that may have reduced functionality due to the unrecoverable startup failure). Using the side band channels, management controller 152 may perform management commands that may include, for example, accessing secured data, providing instructions to use the data, obtaining information regarding an operating state of hardware resources 150, installing management entities on hardware resources 150 using the data, and/or performing any other actions.

Thus, using processes and interactions shown in FIG. 2A, a portion of the startup data that is unavailable for use in startup of a data processing system may be reconstructed, using a management controller, and used to startup the data processing system in an event that the data processing system is unable to startup using the startup data stored on a boot storage device hosted by the data processing system. By doing so, the data processing system may be placed in a desired operating state for providing computer-implemented services.

Turning to FIG. 2B, a second interaction diagram in accordance with an embodiment is shown. The interaction diagram may illustrate processes and interactions that may occur during storing of new startup data used to perform a startup of a data processing system.

To do so, new startup obtainment process 220 may be performed. During new startup obtainment process 220, updated startup data used to perform a startup of the data processing system may be obtained. The updated startup data may, for example, include new firmware, configuration files, etc. used to perform a startup of data processing system 100A. The updated startup data may be obtained from an external entity (e.g., management system 102, user devices 104, etc.). For example, the updated startup data may be obtained by management controller 152 from management system 102 via an out-of-band communication channel (e.g., out-of-band channel 172 shown in FIG. 1B).

The updated startup data may include, for example, a copy of an image of a management entity, system configuration files, firmware, and/or any other information. To obtain the updated startup data, management controller 152 may receive the updated startup data from a remote entity, for example, management system 102 via out-of-band communication channels (e.g., out-of-band channels 172). Once obtained, the updated startup data may be stored, at least temporarily, by management controller 152.

For example, a new startup image may be obtained as part of an update process that may update the data stored in boot storage device 191. However, performing the update process may include risk of corruption of data and/or degradation to boot storage device 191. Consequently, an unrecoverable startup failure (e.g., as identified in startup status monitoring process 200 in FIG. 2A) may occur in the future due to data corruption and/or degradation to boot storage device 191. Refer to FIG. 2A for additional information regarding managing startup data during an unrecoverable startup failure.

Once the startup data is verified, the startup data may be stored in a first storage device (e.g., boot storage device 191) and a second storage device (e.g., storage device 192). For example, at interaction 222, the startup data may be provided to boot storage device 191 by management controller 152. For example, the startup data may be provided by transmitting the verified copy of the startup data along with instructions (e.g., a write request) via side band channel 174B, utilizing a firmware interface, and/or via any other processes.

The verified copy of the startup data may be restored on the boot storage device 191. For example, during a restoring process, a copy of startup data (e.g., that may include erroneous data causing the unrecoverable startup event) hosted by boot storage device 191 may be replaced with the latest stable copy of the startup data. To do so, the existing startup data stored on boot storage device 191 may be removed (e.g., deleted from the non-volatile memory), the latest stable copy of startup data may be written to memory of boot storage device 191, boot storage device 191 be flashed using the latest stable copy of startup data, and/or any other actions may be performed.

At interaction 224, a request to store the startup data in a boot partition may be provided to storage device 192 from management controller 152. The request may include, for example, an address for the boot partition if determined by management controller 152 that the boot partition exists, a request to write data to the boot partition, and/or any other information. If determined that the boot partition does not exist, the request may also indicate to storage device that the boot partition is to be created.

To create the boot partition on storage device 192, boot partition establishment process 226 may be performed. During boot partition establishment process 226, a portion of storage resources of storage device 192 may be allocated for boot data. For example, to allocate the portion of storage resources, a size of a partition (e.g., a logical partition) may be configured, the portion of storage resources may be formatted, and/or any other actions may be performed to establish the boot partition. Once established, the boot partition (e.g., 193) may store startup data that may be isolated from other data stored on storage device 192.

At interaction 228, the startup data may be provided to boot partition 193 of storage device 192 for storage. For example, the latest stable copy of startup data may be stored on the boot partition by (i) issuing, by management controller 152, a write request to storage device 192 via side band channel 174C, (ii) identifying, by storage device 192, a physical storage location (e.g., a flash memory cell) for the boot partition, (iii) writing the startup data to the storage location, and/or performing any other actions. As a result the startup data may be stored in the boot partition (e.g., boot partition 193 shown in FIG. 1C) of storage device 192.

Thus, using processes and interactions shown in FIG. 2B, new startup data may be obtained and stored, using a management controller, in a boot storage device and/or a boot partition of a storage device hosted by the data processing system. By doing so, the startup data may be obtained, by a management controller, when an unrecoverable startup failure is identified during a future startup of the data processing system and used to initiate a new startup of the data processing system to place the data processing system in a desired operating state.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage a data processing system. FIG. 3 illustrate a method that may be performed by the components of the system of FIGS. 1A-1C. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a data processing system in accordance with an embodiment is shown. The method may be performed, for example, by a data processing system, a management system, a communication system, a management controller, hardware resources, and/or other components illustrated in FIGS. 1A-2B.

At operation 300, an identification may be made that a portion of startup data stored in a boot storage device is unavailable for use in startup of the data processing system. The portion of the startup data may be required for completion of the startup. The identification may be made by a management controller of the data processing system. Because in-band channels may have limited functionality during the booting and/or as a result of the undesired boot event, the management controller may obtain information (e.g., startup data, results of processes performed, etc.) regarding the portion of the startup data from a processor of the data processing system using a side band channel. For example, management controller 152 may identify an occurrence of a read failure (e.g., due to data corruption) when processor 190 attempts to read the startup data from boot storage 191.

At operation 302, a copy of the startup data may be made from the boot storage device into memory of hardware resources of the data processing system. The copy of the startup data may be made by the management controller by (i) reading the startup data from the boot storage device (via the corresponding side band channel), (ii) using error correction codes to identify the blocks that are corrupted, (iii) storing the copy of the startup data into memory of the data processing system, and/or (iv) any other methods.

At operation 304, replacement data for the portion of the startup data may be obtained. The replacement data may be obtained by the management controller and from a boot partition of a storage device via a side band channel. The replacement data for the portion of the startup data may be obtained by: (i) transmitting a read request (e.g., an identifier, file address, etc.) to the storage device for the replacement data for the portion of the startup data, (ii) locating, by the storage device, the requested replacement data for the portion of the startup data, (iii) transmitting the replacement data for the portion of the startup data via the side band channel and/or using a data transfer protocol (e.g., NVMe), validating an integrity of the replacement data for the portion of the startup data, and/or via any other processes.

At operation 306, an instance of the startup data may be reconstructed. The instance of the startup data may be reconstructed by the management controller using the copy of the startup data and the replacement data. Reconstructing the instance of the startup data may be performed, for example, by overwriting the portion of the startup data that is unavailable with the replacement data while hosted in memory of the hardware resources of the data processing system. To do so, the management controller may communicate with the storage device using a side band channel.

At operation 308, the startup may be performed using the reconstructed instance of the startup data to place the data processing system in the desired operating state. The startup may be initiated by a processor of the hardware resources. The startup process may be initiated by: (i) sending a reset signal to the processor (e.g., by the management controller), (ii) triggering an updated startup process (e.g., based on the reconstructed startup data), (iii) executing instructions indicated by the reconstructed startup data in memory, (iv) loading an operating system into memory of the data processing system, and/or performing any other actions to place the data processing system in a desired operating state.

At operation 310, computer-implemented services may be provided by the data processing system and while in the desired operating state. The computer-implemented services may be provided by: (i) installing a new management entity (e.g., an application, driver, firmware etc.), (ii) providing an interface for a user of the data processing system, and/or via any other processes.

The method may end following operation 310.

Using the method shown in FIG. 3, operation of a data processing system may be managed using a management controller to obtain and to store a recovery image hosted by a storage device in an event that an unrecoverable boot event is identified during an attempted booting of the data processing system. The management controller may use side band channels to perform monitor the booting of the data processing system, obtain the recovery image from a remote entity via out-of-band communication methods and/or store the recovery image in a boot partition of the storage device. By doing so, a processor hosted by the hardware resources may initiate a new boot using the recovery image to boot the data processing system into a desired operating state.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations.

System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor orsho multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of a data processing system, the method comprising:
making, by a management controller of the data processing system, an identification that a portion of startup data stored in a boot storage device is unavailable for use in startup of the data processing system, the portion of the startup data being required for completion of the startup;
based on the identification:
making, by the management controller, a copy of the startup data from the boot storage device into memory of hardware resources of the data processing system;
obtaining, by the management controller and from a boot partition of a storage device via a side band channel, replacement data for the portion of the startup data;
reconstructing, by the management controller, an instance of the startup data using the copy of the startup data and the replacement data;
performing, by a processor of the hardware resources, the startup using the reconstructed instance of the startup data to place the data processing system in a desired operating state; and
providing computer-implemented services while the data processing system is in the desired operating state.

2. The method of claim 1, wherein the instance of the startup data comprises at least one characteristic of a list of characteristics consisting of:
a complete representation of the startup data; and
a memory data structure stored in the memory.

3. The method of claim 1, wherein making the identification comprises:
reading error correction code data for the portion of the startup data from the boot storage device; and
identifying, based on the error correction code data, that the portion of the startup data is unrecoverable in order to use in the startup of the data processing system.

4. The method of claim 3, wherein the portion of the startup data is unavailable due to being unreadable from the boot storage device and unable to be reconstructed due to a level of corruption that exceeds recoverability by the error correction code data.

5. The method of claim 1, wherein making the copy of the startup data is performed while the processor is selectively powered and other components of the hardware resources are depowered.

6. The method of claim 1, wherein obtaining the replacement data comprises:
identifying, by the management controller and via the side band channel, the blocks from the storage device that are corrupted;
identifying, by the management controller, corresponding blocks from the boot partition; and
reading, by the management controller, the corresponding blocks into the memory.

7. The method of claim 1, wherein reconstructing the instance of the startup data comprises:
identifying, by the management controller, the blocks of data corresponding to the portion of the startup data in the memory; and
overwriting the blocks of data with the replacement data in the memory.

8. The method of claim 1, further comprising:
prior to the storing of the startup data:
selectively powering, by the management controller and via a side band channel, the storage device to gain access to the boot partition,
wherein a corrupt recovery image stored in the boot partition is identified while the storage device is selectively powered and other components of the hardware resources are depowered, the corrupt recovery image being unusable during the boot to place the data processing system in the desired operating state.

9. The method of claim 1, further comprising:
prior to making the identification that the portion of the startup data stored in the boot storage device is unavailable for use, selectively powering, by the management controller, the storage device,
wherein the startup data is stored in the boot partition while the storage device is selectively powered and other components of the hardware resources are depowered.

10. A non-transitory machine-readable medium having instructions stored therein, which when executed by a processor, cause the processor to perform operations for managing operation of a data processing system, the operations comprising:
making, by a management controller of the data processing system, an identification that a portion of startup data stored in a boot storage device is unavailable for use in startup of the data processing system, the portion of the startup data being required for completion of the startup;
based on the identification:
making, by the management controller, a copy of the startup data from the boot storage device into memory of hardware resources of the data processing system;
obtaining, by the management controller and from a boot partition of a storage device via a side band channel, replacement data for the portion of the startup data;
reconstructing, by the management controller, an instance of the startup data using the copy of the startup data and the replacement data;
performing, by a processor of the hardware resources, the startup using the reconstructed instance of the startup data to place the data processing system in a desired operating state; and
providing computer-implemented services while the data processing system is in the desired operating state.

11. The non-transitory machine-readable medium of claim 10, wherein making the identification comprises:
reading error correction code data for the portion of the startup data from the boot storage device; and
identifying, based on the error correction code data, that the portion of the startup data is unrecoverable in order to use in the startup of the data processing system.

12. The non-transitory machine-readable medium of claim 11, wherein the portion of the startup data is unavailable due to being unreadable from the boot storage device and unable to be reconstructed due to a level of corruption that exceeds recoverability by the error correction code data.

13. The non-transitory machine-readable medium of claim 10, wherein making the copy of the startup data is performed while the processor is selectively powered and other components of the hardware resources are depowered.

14. The non-transitory machine-readable medium of claim 10, wherein reconstructing the instance of the startup data comprises:
identifying, by the management controller, the blocks of data corresponding to the portion of the startup data in the memory; and
overwriting the blocks of data with the replacement data in the memory.

15. The non-transitory machine-readable medium of claim 10, wherein obtaining the replacement data comprises:
identifying, by the management controller and via the side band channel, the blocks from the storage device that are corrupted;
identifying, by the management controller, corresponding blocks from the boot partition; and
reading, by the management controller, the corresponding blocks into the memory.

16. A data processing system, comprising:
a processor; and
a memory coupled to the processor to store instructions, which when executed by the processor, cause the processor to perform operations for managing operation of a data processing system, the operations comprising:
making, by a management controller of the data processing system, an identification that a portion of startup data stored in a boot storage device is unavailable for use in startup of the data processing system, the portion of the startup data being required for completion of the startup;
based on the identification:
making, by the management controller, a copy of the startup data from the boot storage device into memory of hardware resources of the data processing system;
obtaining, by the management controller and from a boot partition of a storage device via a side band channel, replacement data for the portion of the startup data;
reconstructing, by the management controller, an instance of the startup data using the copy of the startup data and the replacement data;
performing, by a processor of the hardware resources, the startup using the reconstructed instance of the startup data to place the data processing system in a desired operating state; and
providing computer-implemented services while the data processing system is in the desired operating state.

17. The data processing system of claim 16, wherein the instance of the startup data comprises at least one characteristic of a list of characteristics consisting of:
a complete representation of the startup data; and
a memory data structure stored in the memory.

18. The data processing system of claim 16, wherein making the identification comprises:
reading error correction code data for the portion of the startup data from the boot storage device; and
identifying, based on the error correction code data, that the portion of the startup data is unrecoverable to use in the startup of the data processing system.

19. The data processing system of claim 18, wherein the portion of the startup data is unavailable due to being unreadable from the boot storage device and unable to be reconstructed due to a level of corruption that exceeds recoverability by the error correction code data.

20. The data processing system of claim 16, wherein making the copy of the startup data is performed while the processor is selectively powered and other components of the hardware resources are depowered.
